(19) United States
(12) Patent Application Publication
(10) Pub. No.: US 2021/0213765 A1
(43) Pub. Date: Jul. 15, 2021

(54) LIQUID EJECTION APPARATUS AND METHOD OF ATTACHING AND DETACHING WASTE LIQUID CONTAINER

(71) Applicant: Canon Kabushiki Kaisha, Tokyo (JP)

(72) Inventors: Kenji Tamamori, Kanagawa (JP); Tetsushi Ishikawa, Tokyo (JP); Takashi Sugawara, Kanagawa (JP); Keiji Watanabe, Kanagawa (JP); Masafumi Morisue, Tokyo (JP); Seiichiro Yaginuma, Kanagawa (JP)

(21) Appl. No.: 17/147,799

(22) Filed: Jan. 13, 2021

(30) Foreign Application Priority Data
Jan. 15, 2020 (JP) 2020-004208

(51) Int. Cl. B41J 29/17; B41J 2/165

(52) U.S. Cl. CPC B41J 29/17; B41J 2/16517

(57) ABSTRACT

A liquid ejection apparatus includes a liquid ejection head for ejecting liquid and a mounting section for receiving a waste liquid container to be attached thereto. The waste liquid container is capable of receiving and containing the waste liquid discharged from a discharge port arranged in the mounting section. The liquid ejection apparatus has a blocking member for shielding the discharge port in accordance with an operation of removing the waste liquid container from the mounting section. The liquid ejection apparatus minimizes the risk of staining one or both of the user's hands handling the waste liquid container and the user's clothes with the waste liquid remaining on the discharge port of the liquid ejection apparatus.

### BACKGROUND OF THE INVENTION

### Field of the Invention

The present invention relates to a liquid ejection apparatus and also to a method of attaching and detaching a waste liquid container.

### Description of the Related Art

Liquid ejection apparatus typically include inkjet recording apparatus. An inkjet recording apparatus includes a liquid ejection head, which is normally driven to eject liquid ink toward a recording medium. However, the liquid ejection head is not always driven to eject liquid ink for the purpose of data recording. In other words, the liquid ejection head may sometimes be driven to discharge liquid ink and become free from liquid ink for the purpose of servicing or for some other purpose. Japanese Patent Application Laid-Open No. 2018-202648 discloses a waste liquid container for receiving and containing the waste liquid discharged from a liquid ejection head. The mounting section of the liquid ejection apparatus to which the waste liquid container is attached is provided with a discharge port for discharging the waste liquid that has just been discharged from the liquid ejection head further toward the waste liquid container. The discharge port of a liquid ejection apparatus disclosed in Japanese Patent Application Laid-Open No. 2018-202648 becomes exposed when the waste liquid container is removed. Then, the user of the liquid ejection apparatus may touch the discharge port with one or both of the user's hands. Then, the user's hand or hands touching the liquid ejection apparatus and/or the clothes that the user wears can be stained with the waste liquid remaining on the discharge port.

### SUMMARY OF THE INVENTION

The present invention provides a liquid ejection apparatus including: a liquid ejection head for ejecting liquid; a discharge port for discharging waste liquid from the liquid ejection head; and a mounting section for receiving a waste liquid container to be attached thereto, the waste liquid container being capable of receiving and containing the waste liquid discharged from the discharge port, the discharge port being arranged in the mounting section; the liquid ejection apparatus having a blocking member for shielding the discharge port in the mounting section, in accordance with an operation of removing the waste liquid container from the mounting section; for the operation of removing the waste liquid container from the mounting section, the waste liquid container being driven to move from the discharge port along a plane extending orthogonally relative to the direction of discharging the waste liquid, whereas the blocking member being driven to move along the orthogonally extending plane to a position for covering the discharge port.

The present invention also provides a method of attaching a waste liquid container capable of receiving and containing the waste liquid discharged from a liquid ejection head to and detaching the waste liquid container from a mounting section having a discharge port for ejecting waste liquid arranged therein; the discharge port and the waste liquid container being disposed oppositely relative to each other in the state of the waste liquid container attached to the mounting section; for an operation of removing the waste liquid container from the mounting section, the waste liquid container being driven to move from the discharge port along a plane extending orthogonally relative to the direction of discharging the waste liquid, whereas the blocking member being driven to move along the orthogonally extending plane to the position of shielding and covering the discharge port, in accordance with the operation of removing the waste liquid container from the mounting section.

Further features of the present invention will become apparent from the following description of exemplary embodiments with reference to the attached drawings.

### BRIEF DESCRIPTION OF THE DRAWINGS

FIG. 1 is a schematic perspective view of the first embodiment of liquid ejection apparatus according to the present invention.

FIGS. 2A, 2B, 2C and 2D are schematic cross-sectional views and schematic perspective views as viewed from below of a part of the mounting section of the liquid ejection apparatus shown in FIG. 1.

FIGS. 3A, 3B, 3C and 3D are schematic bottom views and schematic cross-sectional views of the mounting section of the second embodiment of liquid ejection apparatus according to the present invention.

FIG. 4 is a schematic perspective view of the blocking member of the third embodiment of liquid ejection apparatus according to the present invention.

FIG. 5 is a schematic perspective view of the blocking member of the fourth embodiment of liquid ejection apparatus according to the present invention.

FIGS. 6A and 6B are schematic bottom views of the mounting section of the fifth embodiment of liquid ejection apparatus according to the present invention.

FIGS. 7A and 7B are schematic bottom views of a mounting section obtained by modifying the mounting section of the fifth embodiment of liquid ejection apparatus according to the present invention.

FIGS. 8A and 8B are schematic bottom views of another mounting section obtained by modifying the mounting section of the fifth embodiment of liquid ejection apparatus according to the present invention.

FIGS. 9A, 9B, 9C and 9D are schematic cross-sectional views and schematic perspective views as viewed from below of the mounting section of the sixth embodiment of liquid ejection apparatus according to the present invention.

### DESCRIPTION OF THE EMBODIMENTS

The object of the present invention is to provide a liquid ejection apparatus that can minimize the risk of staining one or both of the user's hands and the user's clothes with the waste liquid remaining on the discharge port of the liquid ejection apparatus when the user is removing the waste liquid container mounted in the liquid ejection apparatus and also a method of attaching a waste liquid container to and detaching the waste liquid container from the liquid ejection apparatus that can also minimize the risk of staining one or both of the user's hands and the user's clothes with the waste liquid remaining on the discharge port of the liquid ejection apparatus.

Now, currently preferable embodiments of liquid ejection apparatus according to the present invention will be described below by referring to the accompanying drawings.

### First Embodiment

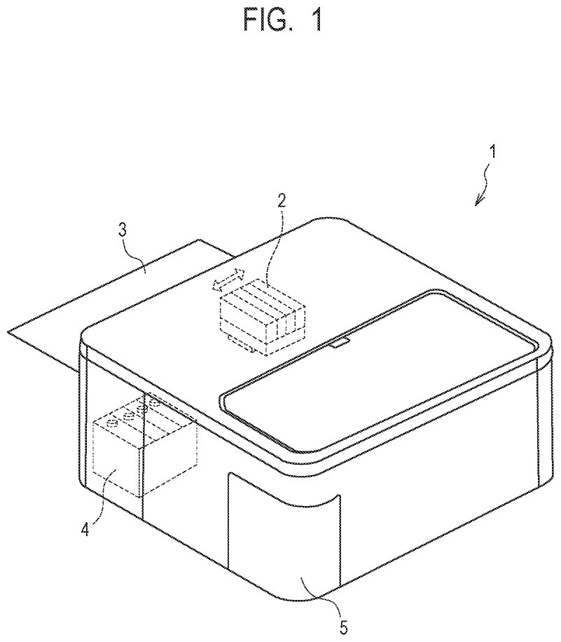

FIG. 1 is a schematic perspective view of the liquid ejection apparatus 1 of the first embodiment of the present invention. The liquid ejection apparatus 1 is driven to operate to eject liquid from its liquid ejection head 2 toward a recording medium 3 for the purpose of data recording. The liquid to be ejected from the liquid ejection head 2 is supplied from a liquid tank 4 to the liquid ejection head 2 by way of a liquid transport pipe (not shown). Additionally, the liquid ejection head 2 sometimes is driven to eject liquid for the purpose of maintenance, which has nothing to do with the purpose of data recording. During such a maintenance work, the liquid (to be referred to as “waste liquid” hereinafter) discharged from the liquid ejection head 2 is received by a cap (not shown) and then transported from the cap and contained in a waste liquid container 5 by way of a waste liquid transport pipe (not shown).

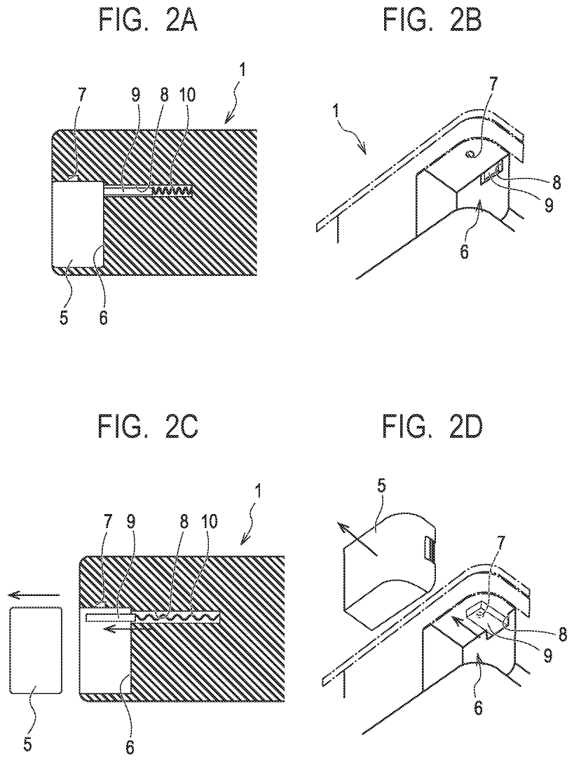

FIGS. 2A through 2D schematically illustrate the waste liquid container 5 and the mounting section 6 for receiving the waste liquid container 5 of the liquid ejection apparatus 1. FIG. 2A is a schematic cross-sectional view of a part of the liquid ejection apparatus 1 and shows the waste liquid container 5 attached to the mounting section 6 of the liquid ejection apparatus 1. FIG. 2B is a schematic perspective view of the part of the liquid ejection apparatus 1 shown in FIG. 2A as viewed from below but the waste liquid container 5 is omitted there. FIG. 2C is a schematic cross-sectional view of the liquid ejection apparatus 1 same as FIG. 2A but illustrates a state of the liquid ejection apparatus 1 where the waste liquid container 5 has been moved away. FIG. 2D is a schematic perspective view of the mounting section 6 as viewed from below and corresponds to FIG. 2C. As seen from FIGS. 2A through 2D, the mounting section 6 of the liquid ejection apparatus 1 is provided with a discharge port 7 for discharging the waste liquid coming from the liquid ejection head 2 as shown in FIG. 1 further away by way of a cap and a waste liquid transport pipe (both of which are not shown). It may also be seen from FIGS. 2A through 2D that the mounting section 6 is equipped with a hole section 8 that is open there and extending into the inside of the mounting section 6. The discharge port 7 is located at the top surface of the mounting section 6, while the hole section 8 is located at an upper part of a lateral surface of the mounting section 6. Differently stated, the discharge port 7 and the hole section 8 are located close to each other in a vertically upper part of the mounting section 6. A blocking member 9 is contained in the hole section 8 and urged toward the inside of the mounting section 6 by a spring 10. The blocking member 6 can horizontally move in the mounting section on a plane extending orthogonally relative to the direction in which waste liquid is discharged from the discharge port 7.

As shown in FIG. 1 and FIG. 2A, the waste liquid container 5 is located vis-a-vis the discharge port 7 when the waste liquid container 5 is attached to the mounting section 6. Thus, the waste liquid discharged from the discharge port 7 is received and contained in the waste liquid container 5 without any problem. Then, the blocking member 9, which is urged by the spring 10, is held in contact with a lateral surface of the waste liquid container 5 and also held in the hole section 8. Note here that, the waste liquid transport pipe that communicates with the discharge port 7 is omitted and not shown in FIGS. 1 and 2A through 2D.

The waste liquid container 5 will sometimes be removed from the mounting section 6 of the liquid ejection apparatus 1 as shown in FIGS. 2C and 2D in order to dispose the waste liquid contained in the waste liquid container 5 or to replace the waste liquid container 5 with another one. As the waste liquid container 5 is removed from the mounting section 6, the inside of the mounting section 6 becomes open. Then, the blocking member 9 is no longer held in contact with a lateral surface of the waste liquid container 5 so that it can move without restriction. Therefore, the blocking member 9, which is urged by the spring 10, jumps out from the hole section 8 to project into an upper part of the mounting section 6. The blocking member 9 eventually gets to a position located vis-a-vis the discharge port 7 and covers the discharge port 7. Namely, in the liquid ejection apparatus 1 of this embodiment, the blocking member 9 is driven to move horizontally to a position squarely facing the discharge port 7 in the mounting section 6 in accordance with the operation of removing the waste liquid container 5 from the mounting section 6. Then, as a result, in the liquid ejection apparatus 1, the discharge port 7 is covered by the blocking member 9 and never becomes exposed even in a state where the waste liquid container 5 has been removed from the mounting section 6. Thus, the risk that the user of the liquid ejection apparatus 1 erroneously touches the discharge port 7 to stain one or both of the user's hands handling the waste liquid container 5 and the clothes the user wears is minimized.

When the waste liquid container 5 is attached back to the mounting section 6, the lateral surface of the waste liquid container 5 is brought back into contact with the blocking member 9 once again in the operation of attaching the waste liquid container 5 back to the mounting section 6, Then, the waste liquid container 5 is horizontally moved back to the predetermined right position, where the waste liquid container 5 squarely faces the discharge port 7, to push back the blocking member 9 into the hole section 8 and compress the spring 10 against the urging force of the spring 10. Thus, the blocking member 9 is forced to move back from the position where it faces the discharge port 7 into the hole section 8. As a result, the waste liquid container 5 squarely faces the discharge port 7 and is brought back into a state where it can receive and contain the waste liquid discharged from the discharge port 7.

Thus, as pointed out above, when the waste liquid container 5 is removed from the mounting section 6, the risk of staining one or both of the user's hands and the user's clothes with the waste liquid attached to the discharge port 7 of the liquid ejection apparatus 1 is minimized. Particularly, in this embodiment, the operation of moving the blocking member 9 away from and that of moving the blocking member 9 back to the position where it squarely faces the discharge port 7 are respectively interlocked with (caused in accordance with) the operation of attaching the waste liquid container 5 to and that of detaching the waste liquid container 5 from the mounting section 6 due to the use of a spring 10. Therefore, the blocking member 9 can reliably be made to move to squarely face and cover the discharge port 7 without requiring significant additional cost. However, note here that the spring 10 may be replaced by a gear train mechanism to realize an arrangement where the operation of moving the blocking member 9 away from and that of moving the blocking member 9 back to the position where it squarely faces the discharge port 7 are respectively interlocked with the operation of attaching the waste liquid container 5 to and that of detaching the waste liquid container 5 from the mounting section 6. Alternatively, the spring 10 may be replaced by a mechanism involving the use of an electric motor to realize an arrangement where the operation of moving the blocking member 9 away from and that of moving the blocking member 9 back to the position where it squarely faces the discharge port 7 are respectively interlocked with the operation of attaching the waste liquid container 5 to and that of detaching the waste liquid container 5 from the mounting section 6. Thus, a variety of drive mechanisms may selectively be employed to realize an arrangement where the operation of moving the blocking member 9 away from and that of moving the blocking member 9 back to the position where it squarely faces the discharge port 7 are respectively interlocked with the operation of attaching the waste liquid container 5 to and that of detaching the waste liquid container 5 from the mounting section 6. Furthermore, two or more of such mechanisms may combinedly be employed to realize such an arrangement.

Also note here that an arrangement for allowing the waste liquid container 5 attachable to and detachable from the mounting section 6 is particularly effective in a liquid ejection apparatus 1 where a continuous liquid supply system is installed and liquid can continuously be supplied to the liquid tank 4 arranged in the liquid ejection apparatus 1 from a refill container, which may typically be a bottle, because liquid tends to be consumed by and consequently waste liquid will be discharged from such a liquid ejection apparatus 1 much more than before. Therefore, more waste liquid can be discharged than ever by realizing an arrangement that allows the waste liquid container 5 attachable to and detachable from the mounting section 6 to make the waste liquid container 5 replaceable.

### Second Embodiment

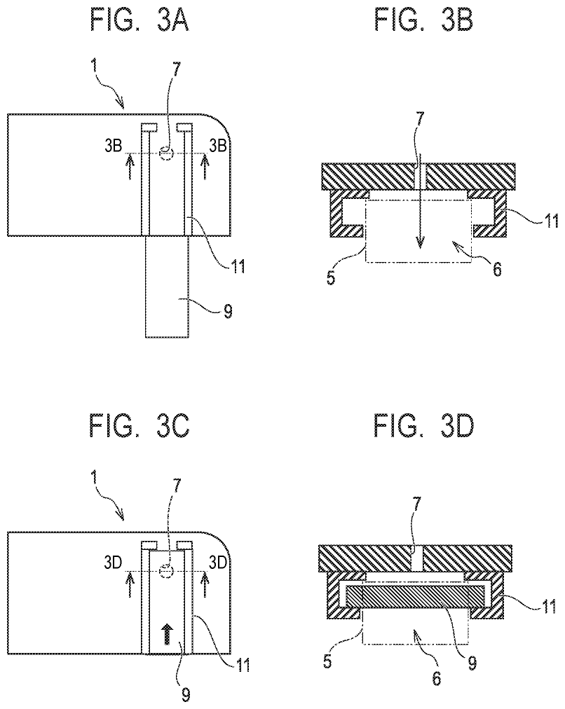

Now, the second embodiment of liquid ejection apparatus according to the present invention will be described below. FIG. 3A is a schematic bottom view of the mounting section 6 of the liquid ejection apparatus 1 of this embodiment, the inside of the mounting section 6 being viewed from below, in a state where a waste liquid container 5 is attached to the mounting section 6 but the waste liquid container 5 is omitted and hence not shown there. FIG. 3B is a schematic cross-sectional view taken along line 3B-3B in FIG. 3A. FIG. 3C is a schematic bottom view of the mounting section 6 of the liquid ejection apparatus 1 of this embodiment, the inside of the mounting section 6 being viewed from below, in a state where a waste liquid container 5 is detached from the mounting section 6. The waste liquid container 5 is omitted and hence not shown in FIG. 3C. FIG. 3D is a schematic cross-sectional view taken along line 3D-3D in FIG. 3C. The liquid ejection apparatus 1 of this embodiment will be described mainly in terms of the differences between the first embodiment and the second embodiment. In other words, the parts of the second embodiment that are the same as or similar to their counterparts of the first embodiment will not be described below.

Like the first embodiment, the blocking member 9 of this embodiment can be driven to move to and away from the position where it squarely faces the discharge port 7 by a drive mechanism, which may typically be a spring 10, interlocking respectively with the operation of detaching the waste liquid container 5 from and that of attaching the waste liquid container 5 to the mounting section 6. However, this embodiment is provided with a guide 11 for guiding the blocking member 9 to move forward and backward (horizontal moves). Because of the provision of the guide 11, the blocking member 9 making a horizontal move can reliably move to the position where it squarely faces the discharge port 7, interlocking with the operation of detaching the waste liquid container 5 from the mounting section 6. Therefore, the blocking member 9 reliably covers the discharge port 7 and gives rise to the effect of minimizing the risk that the user of the liquid ejection apparatus 1 erroneously touches the discharge port 7 to stain one or both of the hands handling the waste liquid container 5 and the clothes the user wears. Even when the waste liquid that adheres to the discharge port 7 unexpectedly falls as waste liquid drops in a state where the waste liquid container 5 has been removed, the blocking member 9 receives the waste liquid drops and hence can prevent the waste liquid drops from falling further from the blocking member 9.

In this embodiment, the size of the waste liquid container 5 is determined such that one of its lateral surfaces touches the blocking member 9 but none of its lateral surfaces do not touch the guide 11 as shown in FIGS. 3B and 3D.

### Third Embodiment

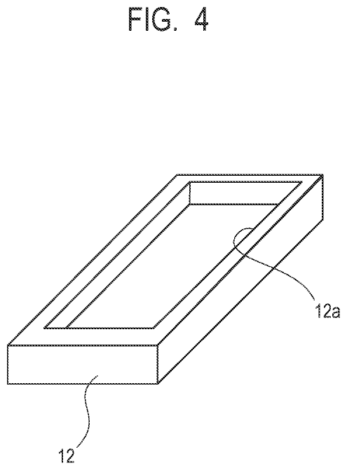

Now, the third embodiment of liquid ejection apparatus according to the present invention will be described below. FIG. 4 is a schematic perspective view of the blocking member 12 of the liquid ejection apparatus 1 of this embodiment. The liquid ejection apparatus 1 of this embodiment will be described mainly in terms of the differences between this embodiment and the first and second embodiments. In other words, the parts of this embodiment that are the same as or similar to their counterparts of the first and second embodiments will not be described below.

Like the first embodiment, the blocking member 12 of this embodiment can be driven to move to and away from the position where it squarely faces the discharge port 7 by a drive mechanism, which may typically be a spring 10, interlocking respectively with the operation of detaching the waste liquid container 5 from and that of attaching the waste liquid container 5 to the mounting section 6. However, as shown in FIG. 4, the blocking member 12 of this embodiment is provided with a recess 12a at a position that can face the discharge port 7. The depth of the recess 12a may typically be not greater than 5 mm but is not limited to such a value by any means. With the above-described arrangement of the blocking member 12, even when the waste liquid that adheres to the discharge port 7 unexpectedly falls as waste liquid drops in a state where the waste liquid container 7 has been removed, the blocking member 12 receives and stores the waste liquid drops. Thanks to the provision of the recess 12a, the blocking member 12 can store waste liquid by a large quantity and gives rise to the effect of minimizing the risk that waste liquid drops fall from the blocking member 12 and the user of the liquid ejection apparatus 1 erroneously touches the discharge port 7 to stain one or both of the hands handling the waste liquid container 5 and the clothes the user wears.

### Fourth Embodiment

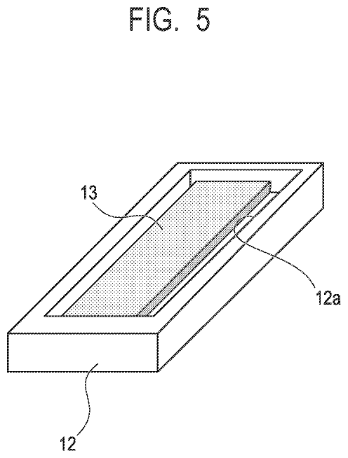

Now, the fourth embodiment of liquid ejection apparatus according to the present invention will be described below. FIG. 5 is a schematic perspective view of the blocking member 12 of the liquid ejection apparatus 1 of this embodiment. The liquid ejection apparatus 1 of this embodiment will be described mainly in terms of the differences between this embodiment and the first through third embodiments. In other words, the parts of this embodiment that are the same as or similar to their counterparts of the first through third embodiments will not be described below.

Like the first embodiment, the blocking member 12 of this embodiment can be driven to move to and away from the position where it squarely faces the discharge port 7 by a drive mechanism, which may typically be a spring 10, interlocking respectively with the operation of detaching the waste liquid container 5 from and that of attaching the waste liquid container 5 to the mounting section 6. As shown in FIG. 5 and like the above-described third embodiment, the blocking member 12 of this embodiment is provided with a recess 12a at a position that can face the discharge port 7. Additionally, a waste liquid absorber 13 is arranged in the recess 12a of the blocking member 12 of this embodiment. The waste liquid absorber 13 may typically be a molded felt member of a fabric material. The waste liquid absorber 13 has a flat profile that substantially matches the profile of the recess 12a and hence substantially fills the recess 12a. However, the thickness of the waste liquid absorber 13 preferably is smaller than the depth of the recess 12a from the viewpoint that the waste liquid absorber 13 should not be brought into contact with and stain the top surface of the mounting section 6 where the discharge port 7 is arranged even when the waste liquid absorber 13 absorbs waste liquid from the discharge port 7 and swells up. When, for instance, the recess 12a of the blocking member 12 has a depth of 5 mm, the thickness of the waste liquid absorber 13 may typically be 2 mm, although the depth of the recess 12a and the thickness of the waste liquid absorber 13 are not limited to the above-described respective values by any means. The waste liquid absorber 13 may be formed by using a material other than felt so long as the waste liquid absorber 13 effectively absorbs liquid. The waste liquid absorber 13 may not necessarily have to fill the recess 12a. It may alternatively fill only part of the recess 12a. The depth of the recess 12a is not limited to 5 mm. In other words, the above-defined depth of the recess 12a can appropriately be modified. Similarly, the height of the waste liquid absorber 13 is appropriately modifiable and may adequately be determined by seeing the depth of the recess 12a.

With the above-described arrangement, when the waste liquid container 5 is removed and the waste liquid adhering to the discharge port 7 accidentally falls as waste liquid drops, the waste liquid absorber 13 in the recess 12a of the blocking member 12 receives the waste liquid and holds the waste liquid in it. Since the waste liquid absorber 13 holds the waste liquid, the waste liquid is prevented from further falling down if the blocking member 12 is subjected to vibrations or an impact to reliably give rise to the effect of minimizing the risk that waste liquid drops fall from the blocking member 12 and that the user of the liquid ejection apparatus 1 erroneously touches the discharge port 7 to stain one or both of the hands handling the waste liquid container 5 and the clothes the user wears. The waste liquid absorber 13 is preferably not bonded to the recess 12a and can be replaced whenever it remarkably becomes stained by the waste liquid it has absorbed.

### Fifth Embodiment

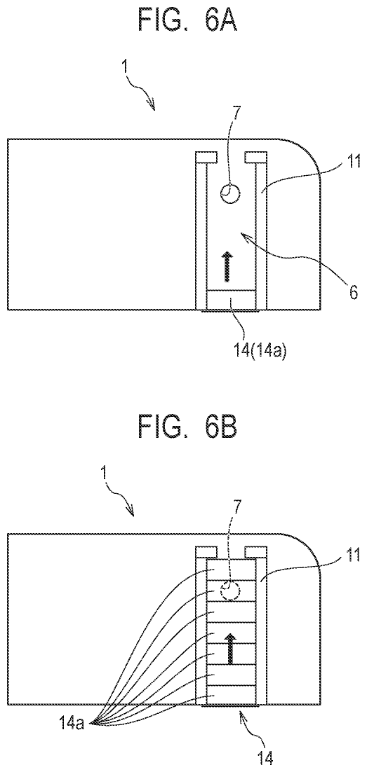

Now, the fifth embodiment of liquid ejection apparatus according to the present invention will be described below. FIGS. 6A and 6B, FIGS. 7A and 7B and FIGS. 8A and 8B are schematic bottom views of the mounting section 6 of the liquid ejection apparatus 1 of this embodiment, showing the inside of the mounting section 6 as viewed from below. The liquid ejection apparatus 1 of this embodiment will be described mainly in terms of the differences between this embodiment and the first through fourth embodiments. In other words, the parts of this embodiment that are the same as or similar to their counterparts of the first through fourth embodiments will not be described below.

The blocking members 9 and 12 of the first through fourth embodiments are flat plate-like members and can be driven to move to and away from the position where it squarely faces the discharge port 7 by a drive mechanism, which may typically be a spring 10, interlocking respectively with the operation of detaching the waste liquid container 5 from and that of attaching the waste liquid container 5 to the mounting section 6. On the other hand, the blocking member 14 of this embodiment is a roller shutter-like member formed by linking a plurality of slats 14a. The roller shutter-like blocking member 14 can selectively take an open position as shown in FIG. 6A and a blocking position as shown in FIG. 6B. At the open position as shown in FIG. 6A, the plurality of slats 14a are laid one on the other to expose the discharge port 7. For the blocking member 14 to shift its position from the open position as shown in FIG. 6A to the blocking position as shown in FIG. 6B, the plurality of slats 14a are driven to move horizontally on a plane extending orthogonally relative to the direction in which the waste liquid is discharged from the discharge port 7 as they are guided by the guide 11 in the mounting section 6. Then, as a result, the plurality of slats 14a are no longer laid one on the other but lined up to lie side by side and cover the discharge port 7. When the waste liquid container 5 is removed from the mounting section 6, the drive mechanism (not shown) of the blocking member 14 spreads the slats 14a of the blocking member 14, which is a roller shutter-like member, interlocking with the operation of removing the waste liquid container 5 to shift the blocking member 14 from the open position to the blocking position. Then, as a result, when the waste liquid container 5 is removed from the mounting section 6, the discharge port 7 is covered by the blocking member 14 and hence not exposed to reliably give rise to the effect of minimizing the risk that waste liquid drops fall from the blocking member 14 and the user of the liquid ejection apparatus 1 erroneously touches the discharge port 7 to stain one or both of the hands handling the waste liquid container 5 and the clothes the user wears. When, on the other hand, the waste liquid container 5 is to be attached to the mounting section 6, the drive mechanism (not shown) of the blocking member 14 lays the slats 14a of the roller shutter-like blocking member 14 one on the other, interlocking with the operation of attaching the waste liquid container 5 to the mounting section 6 to shift the blocking member 14 from the blocking position to the open position. Then, as a result, the waste liquid container 5 becomes ready to receive the waste liquid discharged from the discharge port 7. Thus, the use of a roller shutter-like blocking member 14 having a plurality of slats 14a can reduce the space required to store the blocking member 14 when the discharge port 7 needs to be exposed and hence the blocking member 14 is not needed.

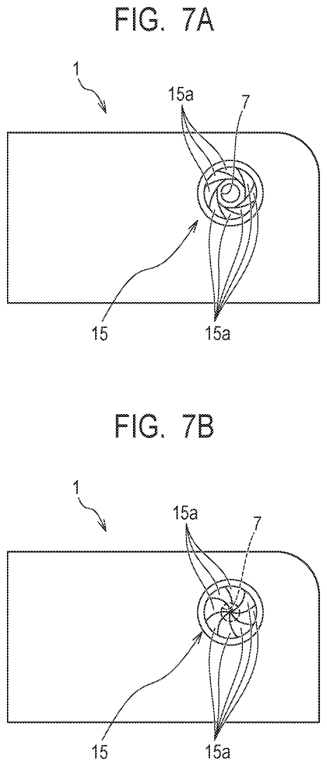

FIGS. 7A and 7B schematically illustrate a blocking member 15 obtained by modifying the above-described blocking member 14 of this embodiment. The roller shutter-like blocking member 14 shown in FIGS. 6A and 6B is formed by a plurality of slats 14a that are linearly driven to move. On the other hand, the modified blocking member 15 shown in FIGS. 7A and 7B is a shutter-like member formed by using a plurality of comma-shaped thin and flat boards 15a. The plurality of comma-shaped flat boards 15a are arranged around the discharge port 7 in the mounting section 6 so as to be rotatable within a plane that is orthogonal relative to the direction in which waste liquid is discharged from the discharge port 7 to allow the shutter-like blocking member 15 to selectively take an open position as shown in FIG. 7A and a blocking position as shown in FIG. 7B. In the open position shown in FIG. 7A, all the plural comma-shaped thin and flat boards 15a are located outside of the circular discharge port 7 to expose the discharge port 7 as viewed in a plan view. On the other hand, for the blocking member 15 to take the blocking position as shown in FIG. 7B, the plural comma-shaped thin and flat boards 15a are driven to rotate and move toward the inside of the circular discharge port 7 so as to cover the discharge port 7. With this modified blocking member 15, when the waste liquid container 5 is to be removed from the mounting section 6, the comma-shaped thin and flat boards 15a are driven to rotate and move toward the inside (so as to move close to each other), interlocking with the operation of detaching the waste liquid container 5 from the mounting section 6 to shift the blocking member 15 from the open position to the blocking position. When, on the other hand, the waste liquid container 5 is to be attached to the mounting section 6, the comma-shaped thin and flat boards 15a are driven to rotate and move toward the outside (so as to move away from each other), interlocking with the operation of attaching the waste liquid container 5 to the mounting section 6 to shift the blocking member 15 from the blocking position to the open position.

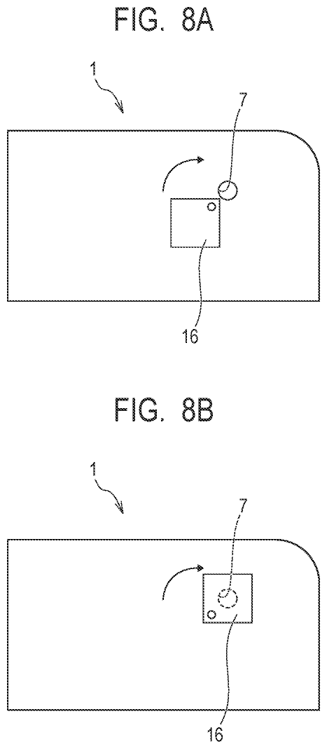

FIGS. 8A and 8B schematically illustrate another blocking member 16 obtained by modifying the above-described blocking member 14 of this embodiment. The blocking member 15 shown in FIGS. 7A and 7B is a shutter-like member formed by using a plurality of comma-shaped thin and flat boards 15a. On the other hand, the modified blocking member 16 shown in FIGS. 8A and 8B is a shutter-like member formed by using a single thin and flat board that is driven to rotate and move in a plane that is orthogonal relative to the direction in which waste liquid is discharged from the discharge port 7 in the mounting section 6. This shutter-like blocking member 16 can selectively take an open position as shown in FIG. 8A and a blocking position as shown in FIG. 8B. In the open position as shown in FIG. 8A, the blocking member 16 that is formed by a single thin and flat board is located outside the position squarely facing the discharge port 7 so as to expose the discharge port 7 and make the discharge port 7 freely accessible from the position squarely facing the discharge port 7. On the other hand, for the blocking member 16 to take the blocking position as shown in FIG. 8B, the blocking member 16 is driven to rotate and cover the discharge port 7. With this modified blocking member 16 again, when the waste liquid container 5 is to be removed from the mounting section 6, the blocking member 16 is driven to rotate and move toward the inside, interlocking with the operation of detaching the waste liquid container 5 from the mounting section 6 so as to allow the blocking member 16 to take the blocking position. When, on the other hand, the waste liquid container 5 is to be attached to the mounting section 6, the blocking member 16 is driven to rotate and move toward the outside, interlocking with the operation of attaching the waste liquid container 5 to the mounting section 6 so as to allow the blocking member 16 to take the open position.

With any of the blocking members 14, 15 and 16 described above and shown respectively in FIGS. 6A and 6B, in FIGS. 7A and 7B and in FIGS. 8A and 8B, when the waste liquid container 5 is removed from the mounting section 6, the discharge port 7 is covered by the blocking member 14, 15 or 16 and hence not exposed to reliably give rise to the effect of minimizing the risk that waste liquid drops fall from the blocking member 14, 15 or 16 and the user of the liquid ejection apparatus 1 erroneously touches the discharge port 7 to stain one or both of the hands handling the waste liquid container 5 and the clothes the user wears. When, on the other hand, the waste liquid container 5 is to be attached to the mounting section 6, the blocking member 14, 15 or 16 is driven to move horizontally or rotate from the position where the blocking member covers the discharge port 7 to make the discharge port 7 squarely face the waste liquid container 5. Then, as a result, the waste liquid container 5 can receive the waste liquid discharged from the discharge port 7. Note that the drive mechanism for driving the blocking member 14, 15 or 16 to move horizontally or rotate, interlocking with the operation of attaching the waste liquid container 5 to or detaching the waste liquid container 5 from the mounting section 6 can be formed by using any of known appropriate drive mechanisms, including springs, gears and electric motors.

### Sixth Embodiment

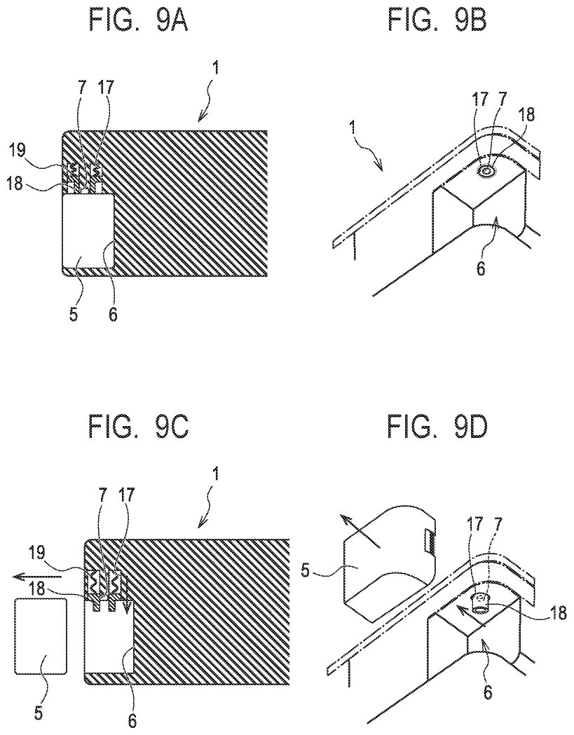

Now, the sixth embodiment of liquid ejection apparatus according to the present invention will be described below. The liquid ejection apparatus 1 of this embodiment will be described mainly in terms of the differences between this embodiment and the first through fifth embodiments. In other words, the parts of this embodiment that are the same as or similar to their counterparts of the first through fifth embodiments will not be described below. FIGS. 9A through 9C schematically illustrate the waste liquid container 5 and the mounting section 6 of this embodiment. FIG. 9A is a schematic cross-sectional view of a part of the liquid ejection apparatus 1 and shows the waste liquid container 5 attached to the mounting section 6 of the liquid ejection apparatus 1. FIG. 9B is a schematic perspective view of the part of the liquid ejection apparatus 1 shown in FIG. 9A as viewed from below but the waste liquid container 5 is omitted there. FIG. 9C is a schematic cross-sectional view of the liquid ejection apparatus 1 same as FIG. 9A but illustrates a state of the liquid ejection apparatus 1 where the waste liquid container 5 has been moved away. FIG. 9D is a schematic perspective view of the mounting section 6 as viewed from below and corresponds to FIG. 9C.

As shown in FIGS. 9A through 9D, the mounting section 6 of this embodiment is provided on the top surface thereof with a circular slit 17 that is centered at the discharge port 7 and also with a cylindrical (hood-like) blocking member 18 that can pass through the slit 17 and move up and down. The cylindrical blocking member 18 is urged downwardly by a spring 19. Both the direction in which the blocking member 18 can move and the direction in which the blocking member 18 is urged by the spring 19 substantially agree with the direction in which waste liquid is discharged from the discharge port 7.

In a state where the waste liquid container 5 is attached to the mounting section 6 as shown in FIG. 9A, the waste liquid container 5 is located squarely vis-a-vis the discharge port 7 and hence the waste liquid discharged from the discharge port 7 is received by and contained in the waste liquid container 5. The blocking member 18 that is urged by the spring 19 is held to a state where the blocking member 18 contacts the top surface of the waste liquid container 5. As shown in FIGS. 9C and 9D, when the waste liquid container 5 is removed from the mounting section 6, the blocking member 18 no longer contacts the top surface of the waste liquid container 5. In other words, the blocking member 18 can now move without being blocked by the waste liquid container 5. Thus, the blocking member 18 that is urged by the spring 19 jumps out from the slit 17 to project downward in a direction that agrees with the direction in which waste liquid is discharged from the discharge port 7 in a state where the blocking member 18 surrounds the discharge port 7. Thus, under this condition, the discharge port 7 is surrounded by the cylindrical (hood-like) blocking member 18. While the discharge port 7 is not covered by the blocking member 18, the one or both of the user's hands handling the waste liquid container 5 and the clothes that the user wears are blocked by the blocking member 18 and hence cannot touch the discharge port 7. Therefore, when the waste liquid container 5 is removed from the mounting section 6, the user would not inadvertently touch the discharge port 7 and the blocking member 18 gives rise to the effect of minimizing the risk that the user of the liquid ejection apparatus 1 erroneously touches the discharge port 7 to stain one or both of the hands handling the waste liquid container 5 and the clothes the user wears.

When the waste liquid container 5 is to be attached back to the mounting section 6 once again, the spring 19 is compressed against its urging force and the blocking member 18 is pushed into the slit 17 to bring the waste liquid container 5 to its proper position, where it squarely faces the discharge port 7. Then, as a result, the waste liquid container 5 is located squarely vis-a-vis the discharge port 7 and restores the state of being capable of receiving the waste liquid discharged from the discharge port 7. The operation of pushing the blocking member 18 into the slit 17 against the urging force of the spring 19 may be executed by bringing the front end of the blocking member 18 into contact with the inclined surface (not shown) of the waste liquid container 5 and sliding the blocking member 18 on the inclined surface. Alternatively, the liquid ejection apparatus 1 of this embodiment may be provided with a mechanism (not shown) for pushing the blocking member 18 into the slit 17 against the urging force of the spring 19 or the blocking member 18 may be pushed into the slit 17 by hand.

This embodiment also provides the effect of minimizing the risk that waste liquid drops fall from the blocking member 18 and the user of the liquid ejection apparatus 1 erroneously touches the discharge port 7 to stain one or both of the hands handling the waste liquid container 5 and the clothes the user wears when the waste liquid container 5 of the liquid ejection apparatus 1 is taken away from the mounting section 6. Additionally, the liquid ejection apparatus 1 of this embodiment can be downsized because this embodiment does not require a space for allowing the blocking member to move horizontally or rotate on a plane orthogonal relative to the direction in which the discharge port 7 discharges waste liquid.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-004208, filed Jan. 15, 2020, which is hereby incorporated by reference herein in its entirety.

What is claimed is:

1. A liquid ejection apparatus comprising:
a liquid ejection head for ejecting liquid;
a discharge port for discharging waste liquid from the liquid ejection head; and
a mounting section for receiving a waste liquid container to be attached thereto, the waste liquid container being capable of receiving and containing the waste liquid discharged from the discharge port, the discharge port being arranged in the mounting section;
the liquid ejection apparatus having a blocking member for shielding the discharge port in the mounting section in accordance with an operation of removing the waste liquid container from the mounting section;
for the operation of removing the waste liquid container from the mounting section, the waste liquid container being driven to move from the discharge port along a plane extending orthogonally relative to the direction of discharging the waste liquid, whereas the blocking member being driven to move along the orthogonally extending plane to a position for covering the discharge port.

2. The liquid ejection apparatus according to claim 1, wherein
the blocking member is a plate-like member and, as the blocking member is driven to move horizontally in the plane extending orthogonally relative to the direction of discharging the waste liquid, the blocking member is capable of moving between a position where the blocking member covers the discharge port and a position where the blocking member does not cover the discharge port.

3. The liquid ejection apparatus according to claim 2, further comprising a guide for guiding the blocking member for horizontal moves.

4. The liquid ejection apparatus according to claim 1, wherein
the blocking member has a recess on the surface thereof that can be made to face the discharge port.

5. The liquid ejection apparatus according to claim 4, further comprising a waste liquid absorber arranged in the recess of the blocking member to absorb the waste liquid discharged from the discharge port.

6. The liquid ejection apparatus according to claim 2, further comprising a drive mechanism for driving the blocking member to move horizontally in accordance with the operation of attaching the waste liquid container to and also with the operation of detaching the waste liquid container from the mounting section.

7. The liquid ejection apparatus according to claim 6, wherein
the drive mechanism comprises a spring.

8. The liquid ejection apparatus according to claim 1, wherein
the blocking member is a roller shutter-like member that is formed by linking a plurality of slats and can alternatively take an open position where the blocking member allows the discharge port to be exposed and a blocking position where the blocking member covers the discharge port by moving each of the plurality of slats horizontally in the plane extending orthogonally relative to the direction of discharging waste liquid.

9. The liquid ejection apparatus according to claim 8, further comprising a guide for guiding the blocking member for horizontal moves of the slats of the blocking member.

10. The liquid ejection apparatus according to claim 1, wherein
the blocking member is a plate-like member and, as the blocking member is driven to rotate in the plane extending orthogonally relative to the direction of discharging waste liquid, the blocking member can move between a position where the blocking member covers the discharge port and a position where the blocking member does not cover the discharge port.

11. The liquid ejection apparatus according to claim 1, wherein
the blocking member is a shutter-like member that is formed by using a plurality of flat boards arranged around the discharge port and, as each of the plurality of the flats boards is turned so as to move away from the other flat boards and come close to the other flat boards in the plane extending orthogonally relative to the direction of discharging waste liquid, the blocking member can alternatively take an open position where the blocking member allows the discharge port to be exposed and a closed position where the blocking member covers the discharge port.

12. The liquid ejection apparatus according to claim 1, wherein
in the operation of removing the waste liquid container from the mounting section, the direction in which the waste liquid container is moved agrees with the direction in which the blocking member is moved.

13. A method of attaching a waste liquid container capable of receiving and containing the waste liquid discharged from a liquid ejection head to and detaching the waste liquid container from a mounting section having a discharge port for ejecting the waste liquid arranged therein;
the discharge port and the waste liquid container being disposed oppositely relative to each other in the state of the waste liquid container attached to the mounting section;
for an operation of removing the waste liquid container from the mounting section, the waste liquid container being driven to move from the discharge port along a plane extending orthogonally relative to the direction of discharging the waste liquid, whereas the blocking member being driven to move along the orthogonally extending plane to the position of shielding and covering the discharge port in accordance with the operation of removing the waste liquid container from the mounting section.

14. The method according to claim 13, wherein
the blocking member is driven to move horizontally to a position where the blocking member squarely faces and covers the discharge port in accordance with the operation of removing the waste liquid container from the mounting section.

15. The method according to claim 14, wherein
the blocking member is driven to move horizontally from the position where the blocking member covers the discharge port to a position where the blocking member does not cover the discharge port in accordance with the operation of attaching the waste liquid container to the mounting section, so as to make the discharge port and the waste liquid container squarely face each other.
